(19) United States
(12) Patent Application Publication
(10) Pub. No.: US 2019/0126181 A1
(43) Pub. Date: May 2, 2019

(54) SEPARATION MODULE FOR SEPARATING OVERSPRAY

(71) Applicant: Jens NEUMANN, Bad Bentheim (DE)

(72) Inventor: Jens NEUMANN, Bad Bentheim (DE)

(21) Appl. No.: 16/097,803

(22) PCT Filed: Oct. 6, 2017
(86) PCT No.: PCT/EP2017/075439

§ 371 Date: Oct. 30, 2018

(30) Foreign Application Priority Data
Oct. 7, 2016 (DE) 20 2016 105 618.7

(51) Int. Cl. B01D 45/08; B05B 15/40

(52) U.S. Cl. CPC B01D 45/08; B05B 15/40

(57) ABSTRACT

The invention is a device—separation module—(10) for separating overspray, having a stepped surface structure, wherein, in the stepped surface structure, each step has a horizontal face (22) and wherein at least one vertical face (24) adjoins each of the horizontal faces (22), wherein a vertical face (24) between two horizontal faces (22) has at least one opening for admitting an untreated gas stream, loaded with overspray, into the interior of the separation module (10), wherein inside the separation module (10), below individual horizontal faces (22) and adjoining a vertical face (24) which has at least one opening, there are vertical channels (26), and wherein at least individual channels (26) comprise a plurality of chambers separated by partitions (30) with a progressive structure; and a use of such a separation module (10), for example in a device for separating overspray.

### BACKGROUND OF THE INVENTION

### Field of the Invention

The invention concerns a device for separating ‘overspray’, and a separator that can be used in a device of this type.

### Description of Related Art

As is well known, overspray is the proportion of a material sprayed in spraying applications, for example paint and similar, which does not reach a particular workpiece, object or similar, instead escaping into the environment in the form of spray mist. Specifically, the invention concerns a device for separating overspray from the overspray-containing cabin air (raw gas) of coating systems, in particular paint systems. As is generally known, there the overspray is taken up by an airflow and conveyed to a separation device that functions as a device for separating overspray (the term “separation device” is hereinafter sometimes used as a short form for “device for separating ‘overspray’”). The separation device removes a part of the airstream (raw gas stream), ideally the majority of the solids (paint particles, pigments, fillers, etc.) and/or droplets (liquid paint portions in the form of solvents, fillers, binders, etc.) carried along by the airstream in the form of overspray. For this type of separation of overspray from the airstream directed through the separation device, the separation device comprises one module as a minimum, or several modules, which for the sake of simplification are referred to in the following as separation modules, even if in some cases they not only perform separation but also, for example, filtration.

### SUMMARY OF THE INVENTION

One object of the innovation described in the following is to specify a further design of a separation module that can be used in a separation device.

According to the invention, this is solved by means of a separation module for the separation of overspray using the features of claim 1. In accordance with that claim, the separation module is characterized by a stepped surface structure, wherein each step of the stepped surface structure has a horizontal or for the most part horizontal face, and wherein at least one vertical or for the most part vertical face adjoins each of the horizontal faces. A vertical face located between two horizontal faces has at least one opening for the entry of a raw gas stream that contains overspray into the interior of the separation module. Following a vertical face provided with at least one opening, the interior of the separation module contains vertical channels under some horizontal faces, wherein at least some channels comprise a plurality of chambers separated by separating faces that have a progressive structure.

The special feature of the innovation proposed here is the stepped surface structure, i.e. a stepped structure of an outer surface that during operation is exposed to an air stream that contains overspray, and the channels under at least some of the steps. The stepped surface structure allows largely uniform loading of the separation module “in the surface”. The channels in the interior of the separation module allow largely uniform loading “in the body”. A separation module of the type proposed here is therefore characterized by its provision of excellent separation and an associated long service life.

Advantageous embodiments of the invention are the subject matter of the dependent claims. The references used herein refer to the further development of the subject matter of the independent claim by the features of the respective dependent claim. These should not be considered to be announcing the attainment of independent objective protection for the feature combinations of the related dependent claims. Further, with respect to an interpretation of the claims as well as the description of a more detailed specification of a feature in a dependent claim, it is to be assumed that such a restriction is not present in the respective preceding claims as well as in a more general design of the present separation module. Any reference in the description to aspects of dependent claims should therefore be explicitly read as a description of preferred but optional features, even without a specific reference to this effect.

In one embodiment, the separation module in each case has a vertical face—which is provided with at least one opening—on several levels, each of which belongs to one step. As each vertical face contains at least one opening, each vertical face of this type allows an inflow of raw gas that contains overspray into a channel that connects behind and underneath a face of this type on the interior of the separation module. This is where the actual separation of overspray takes place.

In a further embodiment, the separation module has several steps, each with surrounding vertical faces, wherein each of these vertical faces is provided with at least one opening to the interior of the separation module. The number of steps determines the distribution of the respective “ring-shaped” channels over the bottom face of the separation module, and a certain number of steps, for example three, four, five, six or more steps, guarantees the abovementioned uniform loading of the separation module “in the surface”.

With respect to those “ring-shaped” channels of which a separation module is comprised, the particular design of a separation module can also be defined by the fact that it has at least a first and a second ring-shaped channel in its base, wherein the first and the second channel share a center point, wherein the first and the second channel each have a horizontal face delimiting the channel in the inflow direction, and wherein the horizontal face of the first channel and the horizontal face of the second channel belong to different steps of the stepped surface structure.

In a further embodiment of a separation module of this type, at least some channels inside the separation module are connected to adjacent, adjoining channels by means of closed vertical boundary faces that are impermeable to the raw gas stream that flows through a channel and contains overspray.

In a still further embodiment of the separation module, this comprises an inner part forming the stepped surface structure and an outer part framing the inner part. An inner part of this type is what was previously described as a separation module. The inner part comprises the horizontal faces, vertical faces, and separating faces as well as the vertical boundary faces, and may be made of cardboard for example, especially corrugated cardboard. The outer part may also be made of cardboard, especially corrugated cardboard.

A separation module of the type proposed here, or an inner part of a separation module of this type, is preferably designed in a foldable form that erects itself when unfolded.

The stepped surface structure of a separation module of the type proposed here or an inner part of such a separation module results, for example, from a design in the shape of a stepped pyramid or in the shape of an inverse stepped pyramid.

The claims filed with the application are proposed formulations without prejudice to obtaining further-reaching scope of protection. Since, in particular, the subject matter of the dependent claims may constitute separate and independent inventions with regard to the state of the art on the priority date, the applicant reserves the right to make these or other combinations of features previously disclosed only in the description and/or drawing, the subject matter of independent claims or divisional application. They may also contain independent inventions, the form of which is not dependent upon the subject matter of the preceding dependent claims.

### BRIEF DESCRIPTION OF THE DRAWINGS

In the following, an exemplary embodiment of the invention is explained in more detail with reference to the drawing. Objects or elements corresponding to one another are provided in all figures with the same reference numerals.

In the Drawing:

FIG. 1 shows an isometric view of an embodiment of a separation module of the type proposed here,

FIG. 2 shows an isometric view of a further embodiment of a separation module of the type proposed here,

FIG. 3 and FIG. 4 show sectional views of a separation module according to FIG. 1 and FIG. 2 respectively,

FIG. 5 shows a sectional view of a separation module section that is designated as a channel, as shown in FIG. 1 and FIG. 3,

FIG. 6 shows a top view of different separating faces in a channel,

FIG. 7 and FIG. 8 show a top view of a separation module as shown in FIG. 1 and FIG. 2 respectively,

FIG. 9 and FIG. 10 show the successive loading of a separation module of the type proposed here with overspray separated from a raw gas stream on the one hand in the face (FIG. 9) and on the other hand in the body (FIG. 10),

FIG. 11 and FIG. 12 show side views of a segment of the separation module as shown in FIG. 2, and snapshots of the segment in usable configuration as well as folded,

FIG. 13 shows a three-dimensional representation of half of a separation module as shown in FIG. 2 with snapshots during separation module folding and during separation module segment folding.

FIG. 14, FIG. 15, FIG. 16 and FIG. 17 show further embodiments of a separation module.

### DETAILED DESCRIPTION OF ILLUSTRATED EMBODIMENTS

The or each exemplary embodiment is not to be understood as a limitation of the invention. Rather, numerous amendments and modifications are possible within the scope of this disclosure, in particular those which, for example, can be gathered by experts with a view to solving the task by combining or modifying some features and/or elements or procedural steps described in the general or specific part of the description and contained in the claims and/or the drawing, in connection with the general or specific part of the description, and which lead to a new object or to new procedural steps or procedural sequences by means of combinable features, including in cases of manufacturing, testing and work procedures.

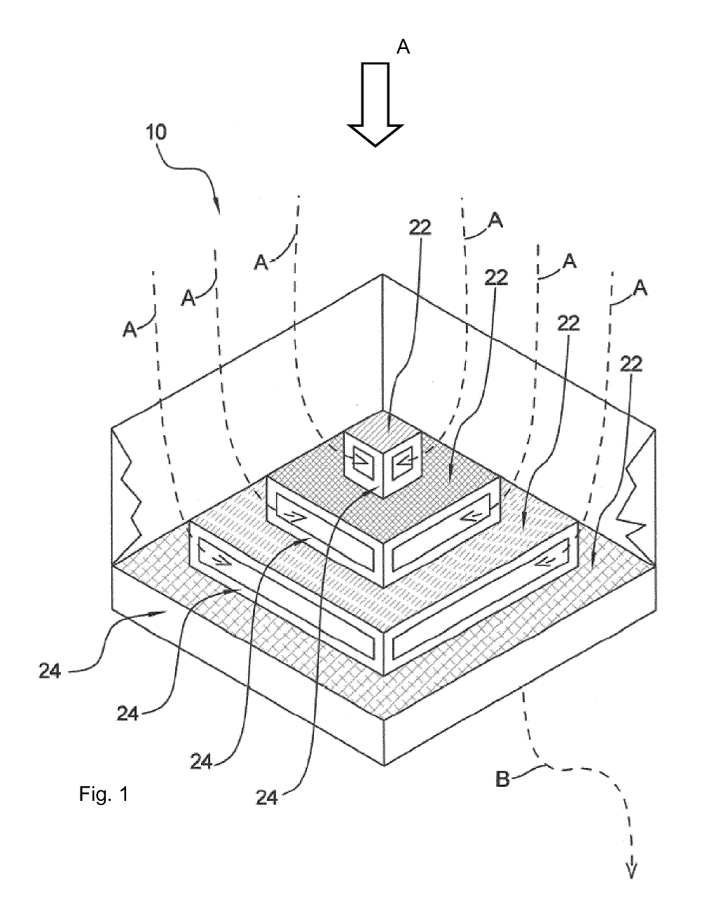

The representation in FIG. 1 shows an isometric view of an embodiment of a separation module (10) proposed here, in schematically simplified form. The stepped shape (stepped surface structure) of the separation module (10) is noticeable. In the following, this form will be referred to as the pyramid form, based on stepped pyramids.

In order to improve the readability of the specification presented here, the following applies: Terms such as “above”, “below”, “higher”, “lower”, etc. refer to a raw gas stream that contains overspray or similar, and that is to be separated. The direction of the raw gas stream (A) is illustrated in some figures, for example in the form of a block arrow (B denotes the air stream exiting downstream of the separation module (10)). The stepped surface structure is the stepped structure of the outer face of the separation module (10) exposed to raw gas stream (A) during operation. A “horizontal face” is a face which is perpendicular or for the most part perpendicular to a main direction of flow of the raw gas stream (A), or which meets the main direction of flow of the raw gas stream (A) on the perpendicular or for the most part on the perpendicular. In this sense, a “vertical face” means a face parallel or at least for the most part parallel to the main direction of flow of the incoming raw gas stream (A). Terms such as “horizontal”, “vertical” and similar therefore have nothing to do with orientation that results from the installed state. Furthermore, in the installed state, various separation module (10) orientations are conceivable; as a result, the reference to the main flow direction of raw gas stream (A) opens up the necessary independence from a previously unknown installation situation and a resulting separator module (10) orientation.

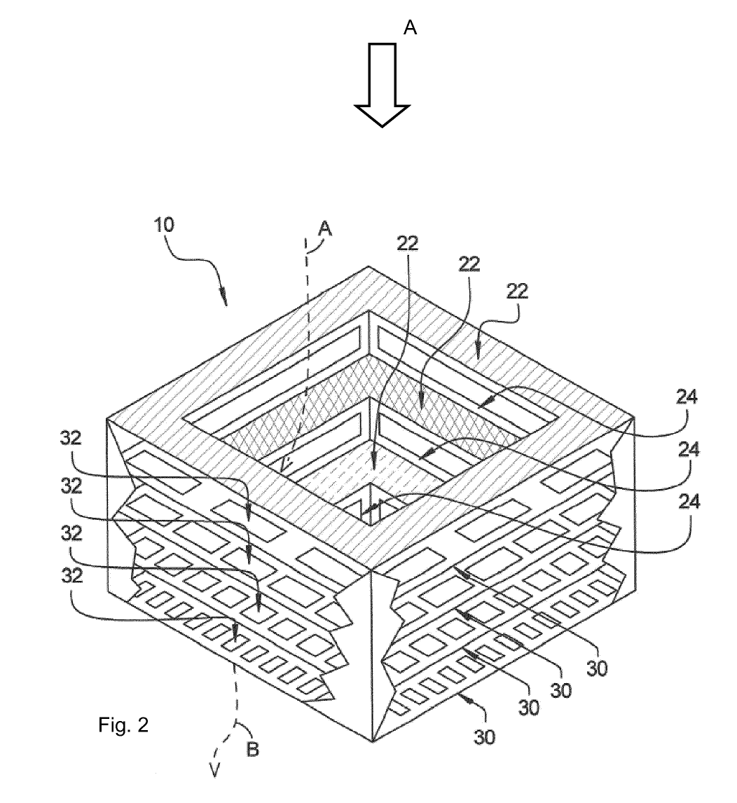

The representation in FIG. 2 also shows an isometric view of a further design of the separation module (10) of the type proposed here, in a schematically simplified form. The shape of the separation module (10) as shown in FIG. 2 is in the shape of an “inverse pyramid”. While the separation module (10) as shown in FIG. 1 has a plurality of levels which are each arranged concentrically with the level below, and whose faces which are exposed to the direction of incoming raw gas stream (A) become successively smaller, the conditions are reversed for the separation module (10) as shown in FIG. 2. There, the uppermost level is a “ring” with four straight side pieces, and at each lower level a step is added that is successively further inward (to the center of the “ring”), with an increasingly smaller surface. It is also the case here that the stepped surface structure results from the stepped structure of the outer face exposed to raw gas stream (A) during operation.

However, common to both forms is that the face exposed to the flow on each level becomes smaller from level to level. In the case of the design shown in FIG. 1, this applies “from bottom to top”. In the case of the design shown in FIG. 2, this applies “from top to bottom”. In the separation module (10) as shown in FIG. 1, the level with the smallest face is at the top (=upstream of all other levels) and the incoming raw gas stream (A) first meets the level with the smallest face. With the separation module (10) as shown in FIG. 2, the level with the smallest face is at the bottom (=downstream of all other levels) and incoming raw gas stream (A) meets the level with the smallest face last. As is further explained below, the time at which raw gas stream (A) meets a certain area of the separation module (10) is of no particular significance for its function. Here, the mention of which area the raw gas stream (A) meets first serves only to illustrate the different shapes of the separation module (10).

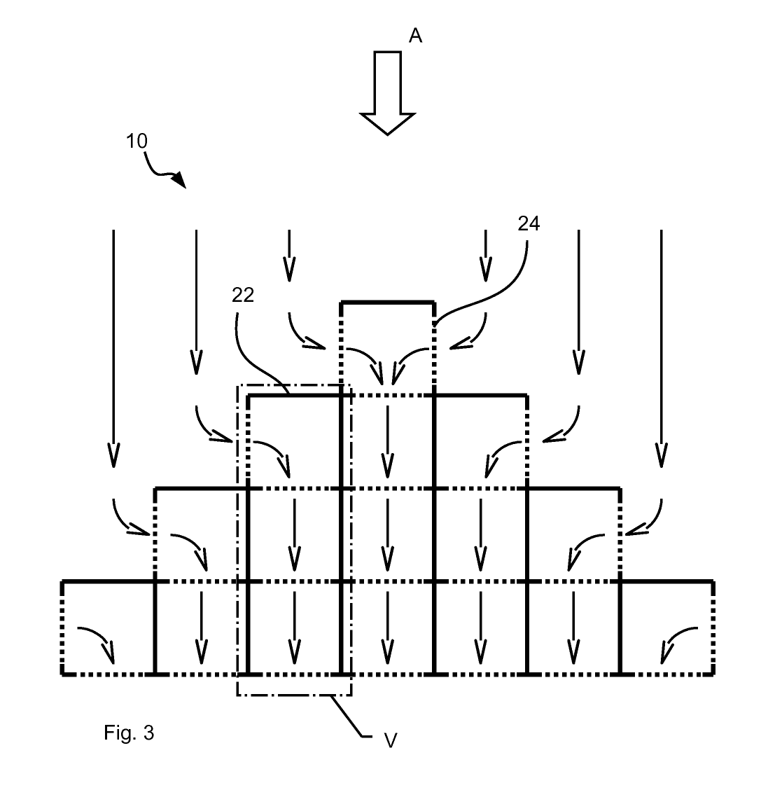

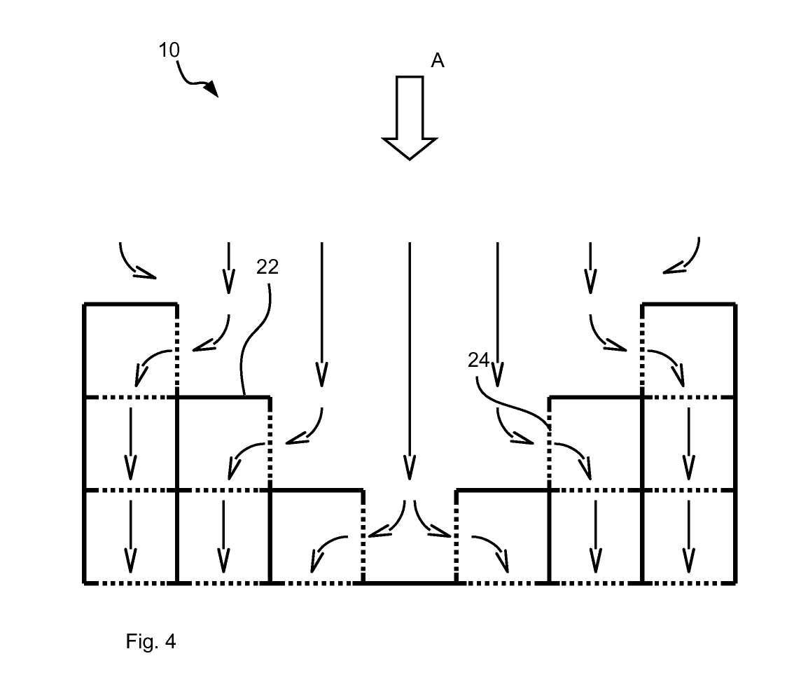

For greater clarity, the representations in FIG. 3 and FIG. 4 show a schematically simplified section through the separation module (10) as shown in FIG. 1 and FIG. 2 respectively, with a sectional plane parallel to the main direction of the raw gas stream (A) and along the longitudinal and center axis of respective the separation module (10), which coincides with the main direction of the raw gas stream (A). In the sectional representations, it is particularly easy to identify the pyramid shape of the separation module (10) as shown in FIG. 1 (FIG. 3) and the inverse pyramid of the separation module (10) as shown in FIG. 2 (FIG. 4).

The separation module (10) comprises a plurality of horizontal faces (22), each of which is in an outer position (can be exposed to flow and are exposed to flow during operation) as well as a plurality of vertical faces (24), which are also in an outer position, through which flow is possible and through which flow occurs at least temporarily during operation; in order to aid clarity, only some of these faces (22 and 24) are designated in the representations. The (outer) horizontal and vertical faces (22 and 24) form the stepped surface structure of the separation module (10). Each step has a horizontal face (22), and at least one vertical face (24) (“below” or “above”) is adjacent to each horizontal face (22). These two vertical faces (24) are adjoined by some horizontal faces (22), (“bottom” and “top”). The horizontal faces (22) of the separator module (10) which are exposed to flow are closed. The vertical faces (24) allow the incoming raw gas stream (A) to enter the interior of the separation module (10). Each of the vertical faces (24) has at least one opening in this respect. This is shown in the representation using dotted lines.

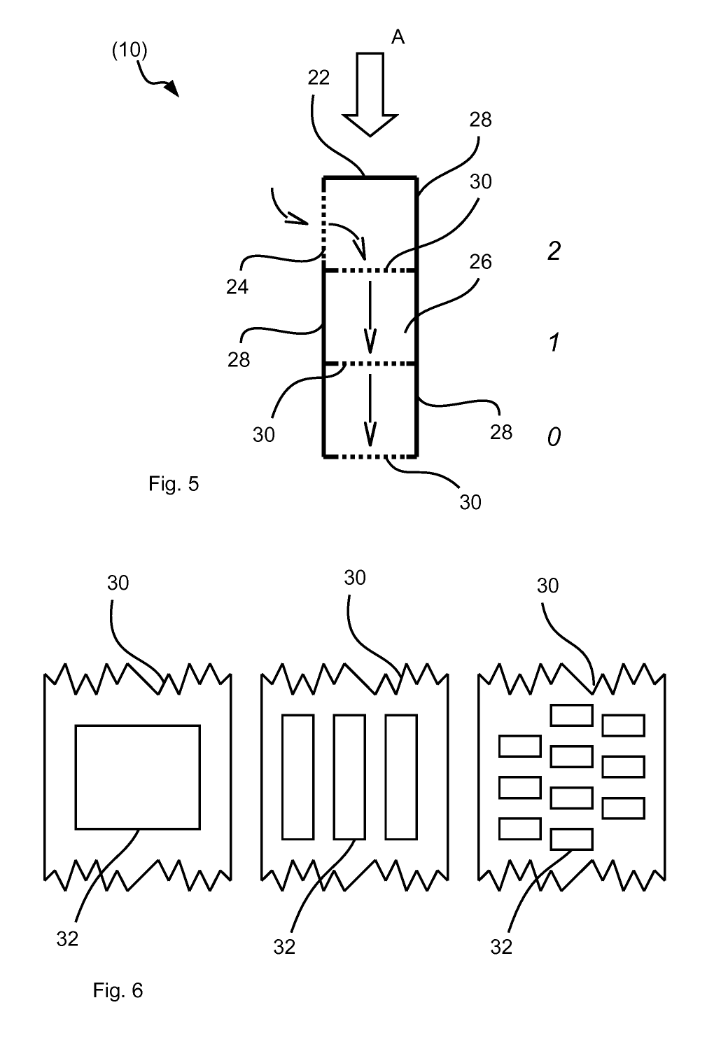

The alternating arrangement of closed (horizontal) and open (vertical) faces (22 and 24) results in a diversion of the raw gas stream (A) when it reaches the separation module (10). This is an alternating arrangement of closed and open faces (22 and 24) in the sense that a closed horizontal face (22) is followed by an open vertical face (24) in the next level down. A design form with openings with horizontal faces (22) that are exposed to flow may also be considered. Following a vertical face (24) provided with at least one opening, the interior of the separation module (10) contains vertical channels (26) (FIG. 5) under some horizontal faces (22), wherein at least some channels (26) comprise a plurality of chambers separated by separating faces (30) (FIG. 5) that have a progressive structure.

In the sectional views, the chambers of a single level are shown as cubes. In the separation module (10) as shown in FIG. 3 and FIG. 1, there is a single chamber at the very top. Below this there is a level where the three chambers comprised by it are shown in the sectional view as a juxtaposition of three “cubes”. The complete level comprises the volume of nine notional cubes of this type. The next level down comprises five chambers and is shown in the sectional view as a juxtaposition of five cubes, wherein the complete level comprises the volume of twenty-five notional cubes of this type. Depending on the size of the separation module (10), this structure continues successively in the lower levels. This applies accordingly for the separation module (10) as shown in FIG. 4 and FIG. 2, with—in short—the number of “cube” chambers decreasing from the edges towards the center.

In FIG. 5, a vertical sequence of some “cubes”/chambers of this type is shown as the basis for the further description, namely the chambers outlined in FIG. 3 with the frame line marked “V”. According to this, the superposed chambers in successive levels of the separation module (10) form a channel (26) in the interior of the separation module (10), namely a channel (26) following a vertical face (24) provided with at least one opening, and below a horizontal face (22) adjoining the top of the vertical face (24). Channel 26 has inner vertical boundary faces (28), in particular closed inner vertical boundary faces (28).

Optionally, the adjacent channels (26) or some of the adjacent channels (26) can also be coupled together. Then at least some vertical boundary faces (28) have openings, which open the channel (26) to an adjacent channel (26).

In the channel (26), between the individual planes (shown in FIG. 5; according to the number of levels shown in FIG. 3, there is “0” for the lowest level, “1” for the level immediately above this, and “2” for the next level immediately above) and at the bottom of the lowest level there is an even (horizontal) separating face (30). In the interior of the separation module (10) there is a plurality of channels (26) of this type, with a depth that varies from step to step and accordingly a number of chambers that varies from step to step, and correspondingly a number of separating faces (30) that varies from step to step.

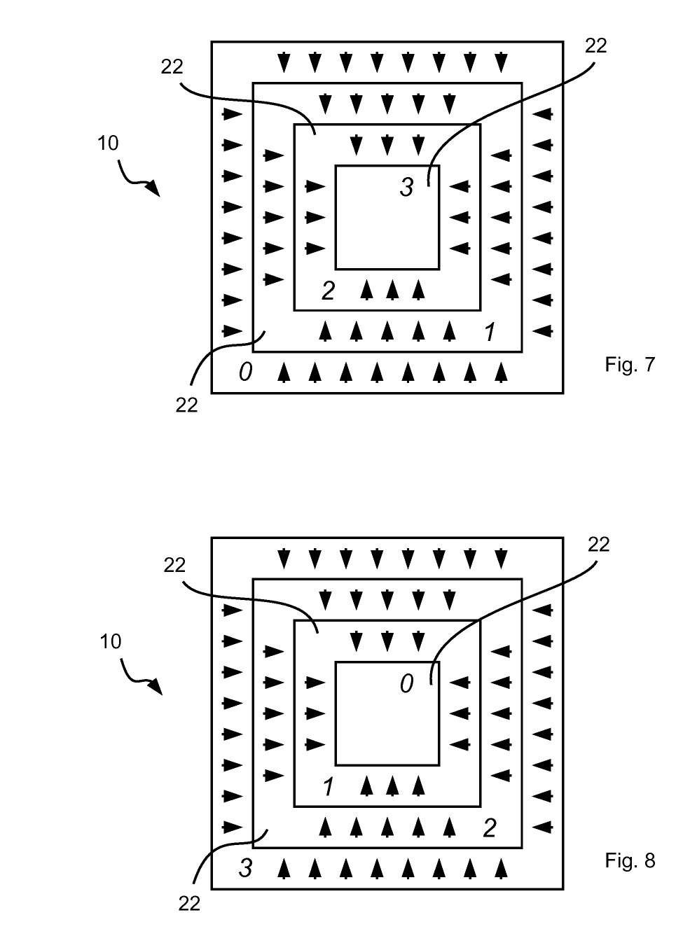

The raw gas stream (A) meeting the direct (outer) horizontal face (22) is diverted, enters the respective channel (26) via the open (outer) vertical face (24), and is diverted again in the process. This already results in considerable turbulence in the raw gas stream (A), which is favorable for the separation of overspray contained in the raw gas stream (A). The separating faces (30) within the channel (26) allow the raw gas stream (A) (that is diverted into channel 26) to pass through, and have openings (32) (FIG. 6) for this purpose. In the respective separating face (30), a respective hole pattern results from the number and size and where applicable also the shape of the openings (32). In a channel (26) with at least two levels, inner vertical boundary faces (28) form the boundary to a channel (26) which is adjacent within the separation module (10) and has a lower number of levels, and to the individual levels there (in FIG. 5, two inner vertical boundary faces (28) on the left side), and to an optionally adjacent channel (26) with a higher number of levels, and to the individual levels there (in FIG. 5, three inner vertical boundary faces (28) on the right side).

A design with openings in the boundary faces (28), which open the respective channel (26) to at least one adjacent channel (26) or to both adjacent channels (26), results in an overall lower separation module (10) flow resistance. In addition, due to the then-existing connection between adjacent channels (26), there is in a sense an alternative for the raw gas stream (A) in the interior of the separation module (10), if the faces effective for separation—in particular the/each separating face (30)—of a channel (26) are already heavily loaded (contain overspray), while there is still less-heavy loading in the adjacent channel (26).

The representation in FIG. 6 shows a top view of the three separating faces (30) from FIG. 5 from left to right in a schematically simplified form, and therefore a possible (example) hole pattern for the individual separating faces (30). The representation in FIG. 6 is intended to illustrate a sequence of openings (32) (not all referred to in FIG. 6) in the separating faces (30); this sequence is hereinafter referred to as the progressive structure. At least some channels (26) of the separation module (10) accordingly comprise a plurality of chambers separated by separating faces (30) with a progressive structure.

The representation in FIG. 6 is to be understood exclusively as an example and, according to the situation shown, the progressive structure results by way of example from an increasing number of openings (32) in the direction of the incoming raw gas stream (A) from level to level (and therefore from separating face (30) to separating face (30)), wherein the individual openings (32) each become smaller from one level to the next level down. In any case, the progressive structure results from a hole pattern that differs from level to level. The progressive structure of the separating face (30) results in flow resistance in a channel (26) that increases from top to bottom, i.e. progressively increasing flow resistance. A progressive structure also results if openings (32) of the same size have an offset arrangement from one level to the next level down (FIG. 17), so that the raw gas stream (A) cannot, without a change in direction, flow through the openings (32) of a plurality of separating faces (30) that follow one another in the flow direction of the raw gas stream (A). In general, the progressive structure of the separating faces (30) therefore denotes an arrangement of successive separating faces (30) which causes increasing turbulence of the raw gas stream (A) and contained overspray along the depth of the respective channel (26) and, due to the turbulence, increasing separation of the overspray along the depth of the channel (26).

This is achieved by the separating faces (30) of the respective channel (26) featuring
openings (32) that become smaller from level to level and/or
a number of openings (32) increasing in size from level to level, and/or
openings (32) of equal size in an arrangement offset from level to level, or becoming smaller from level to level.

This means two things for the separation module (10) overall: One aspect is that the flow resistance of the shortest channels (26), i.e. the flow resistance of those channels (26) which comprise the smallest number of levels/chambers (the outermost areas in FIG. 1 and FIG. 3; the central area in FIG. 2 and FIG. 4), is the lowest and, accordingly, the raw gas stream (A) in a new (“fresh”) separation module (10) initially concentrates on these areas. The other aspect is that the progressive structure of the separating faces (30) leads to an increasing, or at least uniform or for the most part uniform, degree of separation from level to level. This results in uniform loading of the separation module (10) with separated overspray in the vertical direction (in the direction of the main flow of the raw gas stream (A)) and therefore optimum utilization of the individual levels and the faces contained therein. The different flow resistance of the individual levels and the channels (26) formed therein means that the separation module (10) is also optimally utilized in terms of its face, namely the face transverse to the raw gas stream (A).

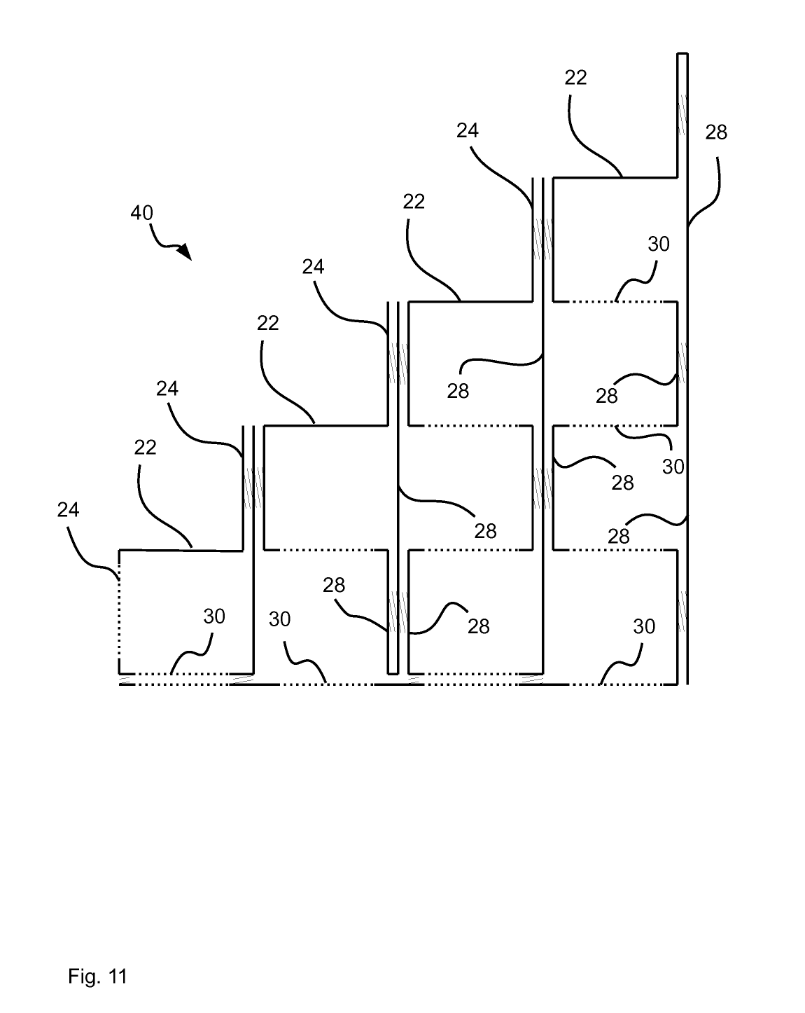

As is evident, with a separation module (10) in the form of an inverse pyramid (FIG. 2 and FIG. 4), the face with the lowest number of levels (see FIG. 8) and the lowest initial flow resistance is located in the center. As the raw gas stream (A) is initially concentrated here due to the flow resistance being lowest in relation to the other areas, the overspray contained in the raw gas stream (A) is for the most part separated here. As the separation of overspray in this area increases, the flow resistance rises there (because in particular the openings (32) in the separating face (30) or the separating faces (30) become obstructed over time). As a result, the difference in flow resistance in this area compared with areas immediately adjacent to its edges decreases as the number of levels there increases. Over time, the raw gas stream (A) is distributed over these areas in accordance with the changing flow resistance and, as the raw gas stream (A) passing through these areas increases, overspray is also separated there and the openings (32) in particular are obstructed accordingly. As a result, the difference between flow resistance in this area and the area immediately adjacent to the edge of this area decreases, causing the raw gas stream (A) to now also be distributed to this area, in which overspray is then successively separated, whereupon the flow resistance increases, and so on. This applies correspondingly to the pyramid shape shown in FIG. 1 and FIG. 3.

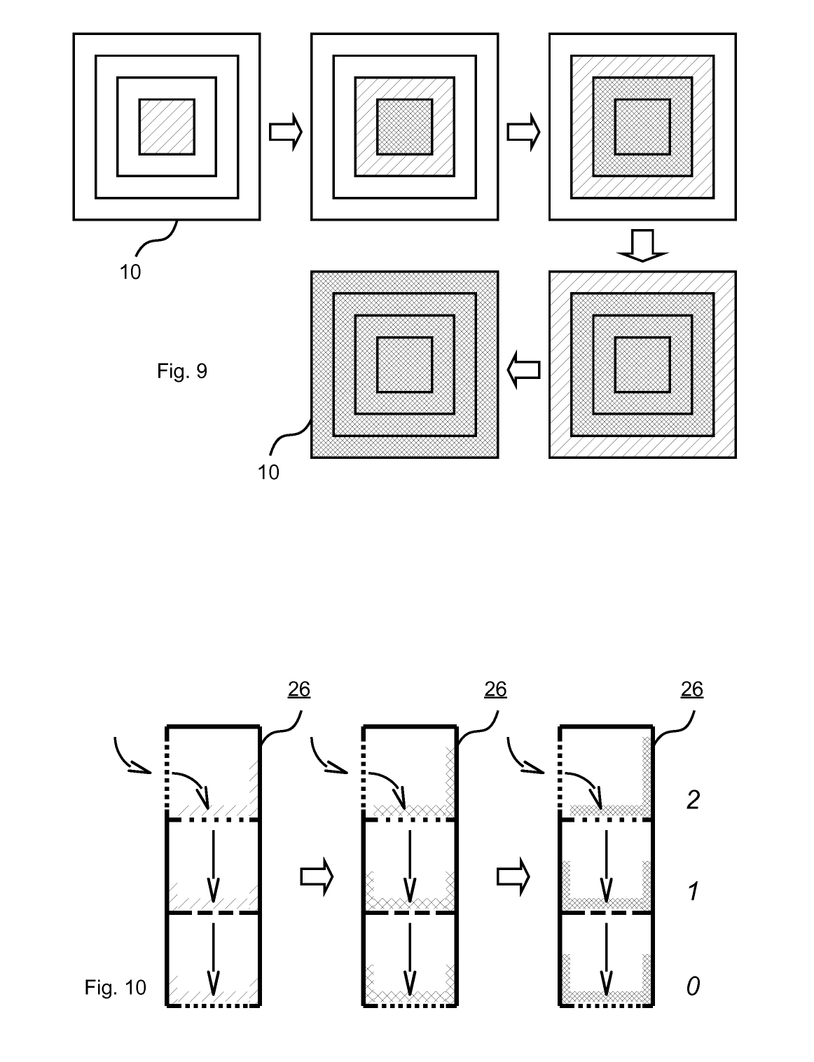

The representations in FIG. 7 and FIG. 8 show the separation module (10) according to FIG. 1 and FIG. 3 or FIG. 2 and FIG. 4 from above in a schematically simplified view, as a result of which the steps and resulting different levels of the pyramid structure can be recognized. In each of the two representations, “0”, “1”, “2” and “3” indicate a number of levels, and the number of levels comprised in each case, in corresponding sections of the separation module (10). According to FIG. 7, a separation module (10) such as is shown in FIG. 1 and FIG. 3 has the lowest level number in the outer area, with the number of levels increasing towards the center (pyramid). As shown in FIG. 8, the lowest number of levels is found on the interior of a separation module (10) such as is shown in FIG. 2 and FIG. 4, wherein the number of levels increases evenly outwards in all directions (inverse pyramid).

The representations in FIG. 7 and FIG. 8 also show the “ring-shaped” sequence of the outer areas of the levels. As is evident, the design shown is not rings with circular boundary lines, but rather “rings” with four straight edges that are adjacent to one another in each case. The outline of the “rings” is therefore rectangular or square. The terms “rectangle” or “square” always also designate a face, which is not the focus here, and so the term “ring” is used in the following, wherein it is always to be read that the term “ring” here does not necessarily mean a shape with circular boundary lines, but expressly also includes shapes bounded by several straight boundary lines (polygon; polygonal chain). Each ring of this type shall have associated with it a channel (26), which shall be located under at least some horizontal faces (22), and its base will be ring-shaped in this sense. The representations in FIG. 7 and FIG. 8 in this respect complete the sectional view—shown in FIG. 5—of a channel (26) into the third dimension along its vertical axis.

Finally, the representations in FIG. 7 and FIG. 8 also show that the raw gas stream (A) which is diverted in this respect, flows around (on all four sides in the preferred design shown) at least some steps in the separation module (10) in the area of the respective vertical faces (24). This is shown in the representations by means of the arrows pointing to the boundary lines of the individual steps, only the faces of which (horizontal faces 22) are visible in top view. The arrows symbolizing the raw gas stream (A) meet the surrounding vertical faces (24) (FIG. 5)—which are not visible in the plan view—of the respective step. The raw gas stream (A) passes through the openings in these vertical faces (24) (at least one opening in each vertical face (24)) into channel 26, which is located under at least some steps, and therefore into the interior of the separation module (10). The overspray contained in the raw gas stream (A) is separated inside the separation module (10) in the channels (26) there, in particular at the separating faces (30).

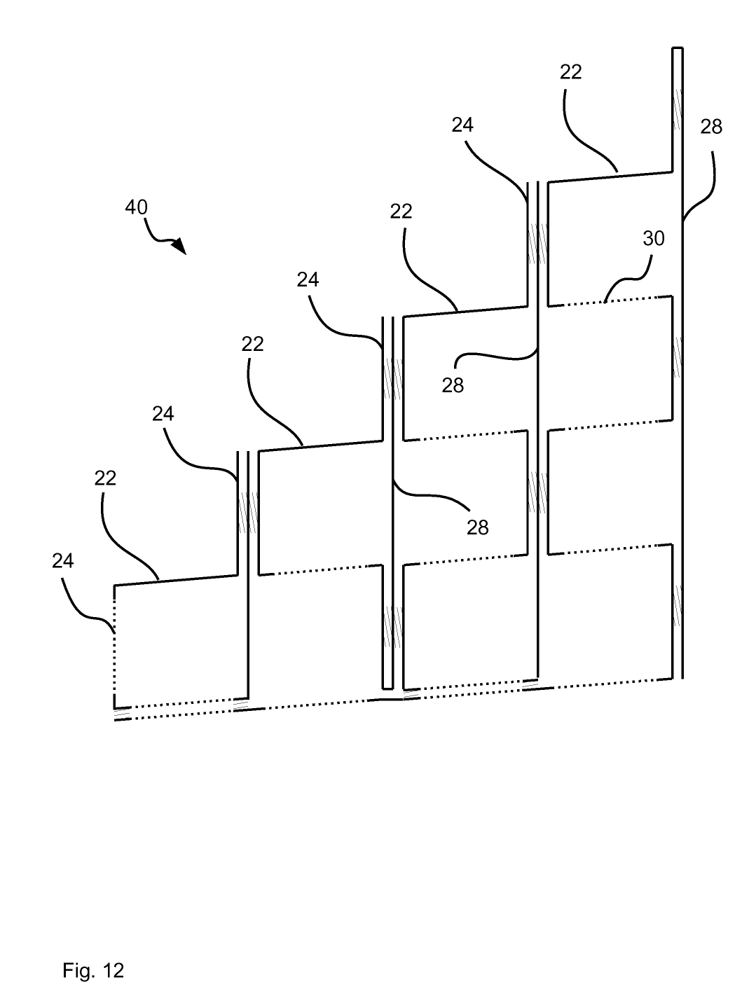

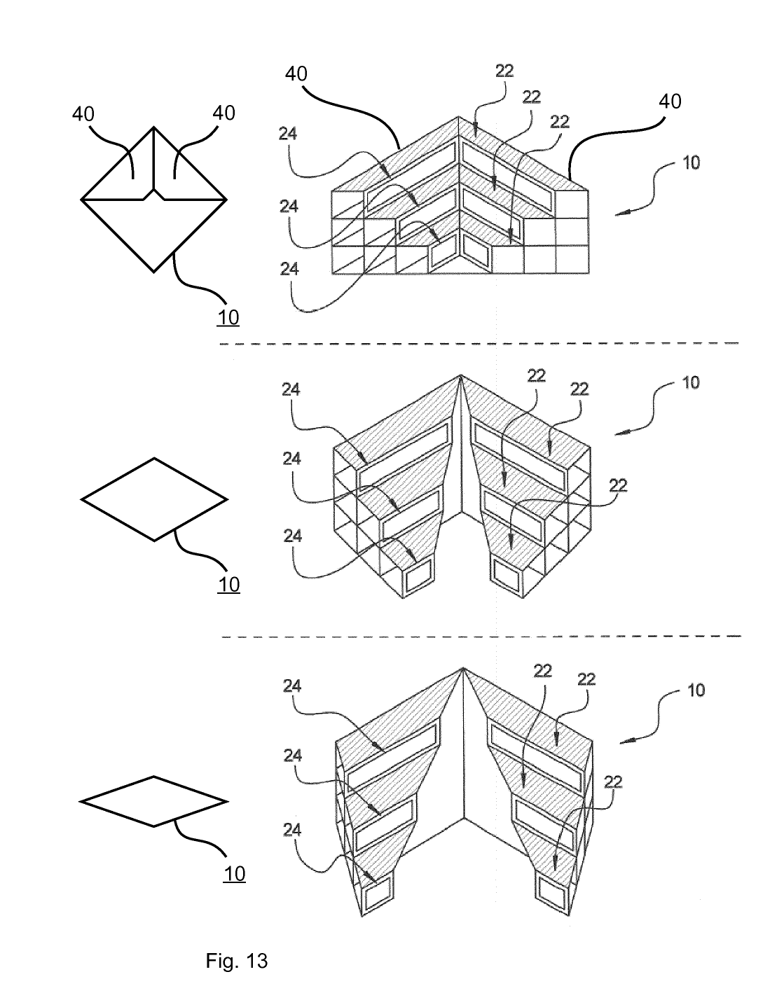

The representations in FIG. 9 and FIG. 10 show a schematically simplified chronological sequence of the loading of a separation module (10) with overspray or similar when used, for example, in a spray booth or a spray line. The representation is based on a separation module (10) as shown in FIG. 2 and FIG. 4. The same applies correspondingly to a separation module (10) such as is shown in FIG. 1 and FIG. 3.

FIG. 9 shows the separation module (10) such as is shown in FIG. 2 and FIG. 4 from above, i.e. as in FIG. 8. The chronological sequence of the displayed processes follows the block arrows, i.e. from left to right in the first line, and from right to left after the transition to the second line. First (top left), the inner (central) area is loaded with the lowest number of levels due to the flow resistance being lowest here in comparison to other areas. This is expressed by the simple diagonal hatching. As soon as the flow resistance there is significantly increased due to corresponding loading, the loading of the adjacent area (top middle) also begins, and no further loading or hardly any further loading takes place in the inner area. A loaded or for the most part loaded area is identified using double hatching. After flow resistance in the area adjacent to the inner area has also considerably increased due to loading, the loading of the next adjacent area begins (top right). This continues successively (bottom right) until ultimately the entire face of the separation module (10) that is exposed to the raw gas stream (A) is loaded.

If the processes illustrated in FIG. 9 are to be described as “surface loading”, FIG. 10 shows the “body loading of the separation module (10)”, i.e. the course of the loading in the vertical direction (parallel to the main flow direction of the raw gas stream (A)). This is explained using a channel (26) comprising several levels of the separation module (10). For the most part, the representation from FIG. 5 is repeated for this purpose. The channel (26) there comprises three levels (level “0”, level “1” and level “2”). Due to the progressive structure of the separating faces (30) (illustrated in FIG. 10 through the use of different line types), the overspray contained in the raw gas stream (A) is simultaneously separated at all separating faces (30). Turbulence in the raw gas stream (A) entering the channel (26) is created as a result of the diversion on the vertical face (24), and the turbulence ensures separation on the inner faces of the chamber adjacent to the vertical face (24). Due to the number and shape of the openings (32) formed therein, a first (uppermost) separating face (30) (level “2” shown in FIG. 10) allows a comparatively large proportion of the raw gas stream (A) to pass for the most part unhindered, and the openings (32) result only in slight additional turbulence in the raw gas stream (A). Accordingly, only a comparatively small proportion of overspray is separated here. Nevertheless, separation takes place and the quantity of overspray contained in the raw gas stream (A) is already reduced at the next level (in Level “1” in the illustration in FIG. 10). For example, the progressive structure of the vertical separating faces (30), which follow each other within a channel (26), is realized here in the form of a separating face (30) with smaller openings (32) and an increased number of smaller openings (32) of this type (offset openings result in additional turbulence). The raw gas stream (A) passes through the openings (32) to the next level down. Before this, a further proportion of the overspray contained in the raw gas stream (A) is separated, wherein more turbulence is created in the raw gas stream (A) here than in the previous level due to the progressive structure of the separating faces (30). The overspray quantity still arriving at the final level (level “0”) in the representation in FIG. 10 and contained in the raw gas stream (A) is therefore further reduced. Here, overspray is separated again at the separating face (30) of this level. For example, for the separating face (30) of the last level of each channel (26), the progressive structure of the separating faces (30), which follow each other in a vertical direction within a channel (26), is realized in the form of a separating face (30) with the smallest openings (32) along the channel (26) and the highest number of openings (32) of this type. This ensures that overspray (still) contained in the final level of the raw gas stream (A) is separated at this separating face (30), or is at least separated for the most part, with the result that the air exiting the lower end of the channel (26) is free of overspray, or at least free of overspray for the most part.

The representation in FIG. 10 shows that overspray is separated at each level (marked by hatching above the separating faces (30) of the indicated channel (26)). In addition, it is shown that the quantity of overspray separated at the individual separating faces (30) increases over time; this is illustrated by different hatching from left to right (FIG. 10, left: initial loading; FIG. 10, center: increasing loading; FIG. 10, right: final loading). The representation in FIG. 10 and the time sequence shown for the resulting loading of a channel (26) of the separation module (10) with overspray demonstrate that the separation module (10) also experiences uniform loading with overspray in the vertical direction (i.e. “in the body”) and is therefore overall (uniform loading in the surface; uniform loading in the body) characterized by excellent separation performance and a correspondingly long service life.

For example, the separation module (10) is made of corrugated cardboard, wherein the individual faces (22, 24, 28, and 30) are created through the corresponding shaping of individual or several sections of corrugated cardboard.

The separation module (10) described thus far for example comprises a frame also made of corrugated cardboard, or is inserted into a frame which surrounds it in a form-fit manner, as shown for example in FIG. 1 and FIG. 2. A separation module (10) in the shape of a pyramid (FIG. 1), for example, is preferably inserted into a separate frame in a form-fit manner. In the case of a separation module (10) in the shape of an inverse pyramid (FIG. 2), the preferred design features outer boundary faces (28) that form a frame in such a way that a separate frame is not necessary, but may nevertheless be present. In combination with its own frame or a separate frame, the separation module (10) described thus far is the inner part and a possibly separate frame is the outer part of a device, which can also in its entirety be referred to as the separation module (10).

A separation module (10) of the type described here is preferably used (with or without its own frame or a separate frame/external part) in a device for separating overspray, not shown here. This would, for example, be a device of the type as described in WO 2016/116393 A, or a device in particular with compartments placed side-by-side and/or one above the other in a level (“module wall”), each of which accepts a separation module (10).

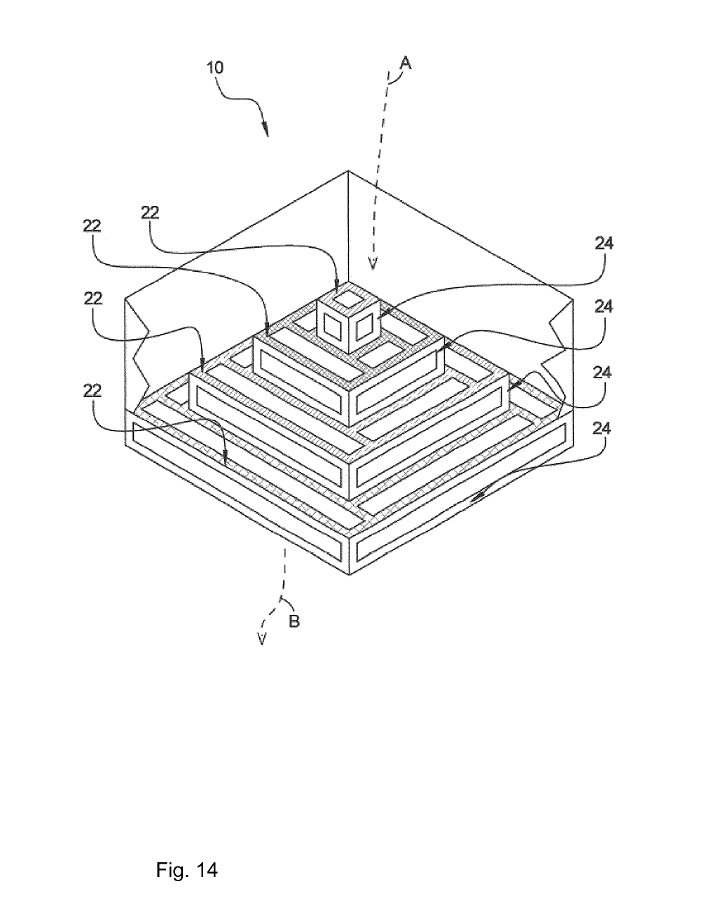

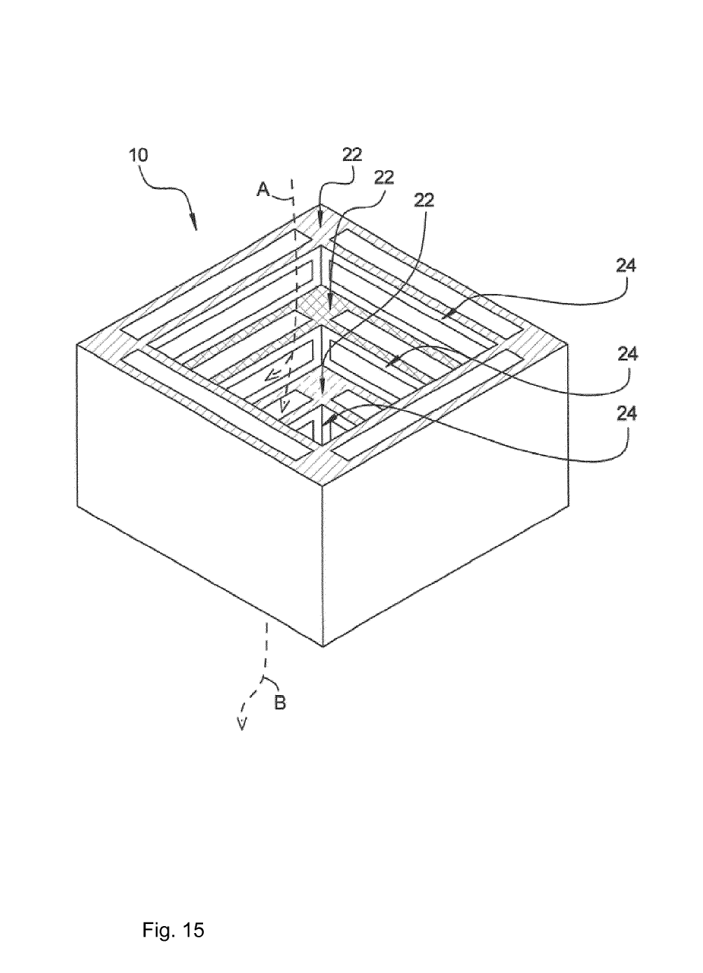

The representations in FIG. 11 and FIG. 12 show a section through one of the four segments (40) of a separation module (10) as shown in FIG. 2 with a sectional plane as shown in FIG. 4, i.e. with a sectional plane along one of the symmetry axes of the separation module (10). The intention is to indicate that a separation module (10)—made for example of cardboard, especially corrugated cardboard—can be folded for transport in a very small space and is “self-erecting” during preparation for use.

FIG. 11 initially shows a possible design of a segment (40) of the separation module (10) with individual material webs with multiple folds (e.g. cardboard, in particular corrugated cardboard). This structure applies correspondingly for the other segments (40) of the separation module (10). The material webs are represented in the form of continuous lines. It is also intended for this to illustrate that the segments (40) can be made of continuous material webs with multiple folds.

In the interest of clarity, a designation of all faces with reference numbers has not been provided (as is also the case in FIG. 12). Reference is made to the preceding FIGS. 1 to 10 in this respect. In addition, there is at least one opening in each of the vertical faces (24); these are not shown.

Fixing points are shown in the form of hatched areas between individual sections of the material webs; the material webs can be fastened together at these points for example using glue, sewing, staples or similar methods. It should be noted here that a connection of this type does not have to exist along the entire depth (transverse to the axis of the sheet with the representation) of the respective segment (40); rather, it is sufficient if a connection of this type exists in the area of the sides of the respective segment (40), i.e. in the areas in which a segment (40) adjoins an adjacent segment (40) in each instance of a complete separation module (10).

FIG. 11 shows the section through the segment (40) of the separation module (10) in ready-to-use (“unfolded”) state. Between the individual face sections (horizontal face (22), vertical face (24), separating face (30), boundary face (28)), there is in each case a right angle)(90° , or at least for the most part a right angle, corresponding to the stepped surface structure. All locations where two face sections meet at this type of angle within a segment (40) of the separation module (10) act like a hinge (film hinge) when the respective segment (40) is folded together, and when the separation module (10) is assembled. For example, the entirety of the outer boundary faces (28) forms an outer wall of the separation module (10) and the entirety of the outer (lowest) separating faces (30) forms a flap-like bottom face of the separation module (10).

The representation in FIG. 12 shows segment (40) from FIG. 11 in a snapshot during folding. It can be seen that all the faces that were previously (FIG. 11) horizontal (22 and 30) are inclined against the horizontal, while the previously vertical faces (28) remain vertical or at least for the most part vertical. It is easy to imagine that further folding of segment 40, i.e. folding beyond the inclination shown in FIG. 12, results in an increasingly flat overall structure until ultimately the previously (FIG. 11) horizontal faces (22 and 30) are oriented vertically or for the most part vertically and, for example, all faces (22) are aligned with the adjacent faces (24) (in one level or at least for the most part in one level).

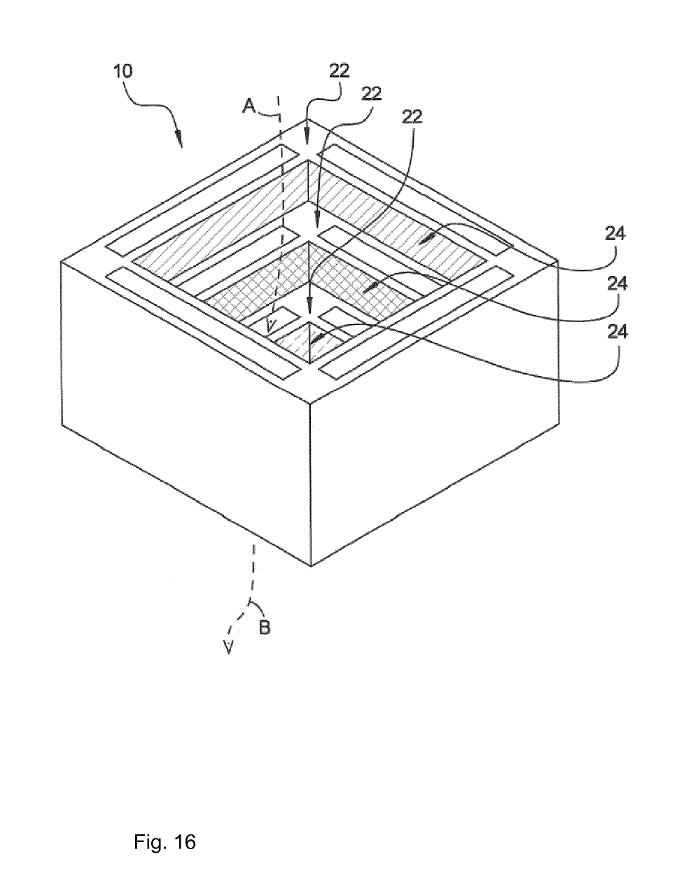

The representation in FIG. 13 shows a separation module (10) such as is shown in FIG. 2 divided from one corner to the opposite corner, and from top to bottom in a three-dimensional representation of the process of folding a separation module (10). To the left of each representation, a schematically simplified two-dimensional top view of the separation module (10) is shown in each case for orientation, wherein FIG. 13 at the top also shows the two segments (40) in this top view.

First (FIG. 13, above), the two segments (40) shown are “unfolded”, resulting in the stepped surface structure with right angles or almost right angles between the individual faces as well as a square or at least rectangular base to the separation module (10).

Below this (FIG. 13, center), the separation module (10) is shown folded with its cube-shaped or cuboid shell outline. In place of the base previously shown (FIG. 13, above) in square form, an increasingly rhombic base results when folding, as two of the opposite corners of the separation module (10) are moved towards one another during folding (the separation module (10) is pressed together by means of pressure on two opposite corners, possibly supported by pressure on the step-shaped surface structure of individual segments (40) or by a pulling movement on the flap-like base of individual segments (40)). This also results in increasing folding of the individual segments (40), as shown in FIG. 12.

Further pressing together (FIG. 13, below) causes the separation module (10) to become increasingly flat and the individual segments (40) to be folded further and further. In this flat-folded form, the separator module (10) takes up very little space during transport and is only brought into the form required for use (as shown in FIGS. 1 to 10 above) at the location of use.

When assembling a separation module (10), the sequence illustrated in FIG. 13, FIG. 11 and FIG. 12 is reversed. With a folded separator module (10), the corners that are furthest from each other are moved toward each other. Starting from a folded separation module (10) with an initially rhombic base, this results in an increasingly unfolded separation module (10) with an increasingly square or rectangular base. Pressing the bases of the individual segments (40) causes these to also unfold in such a way that the configuration shown in FIG. 11 is ultimately created. After unfolding, the configuration is as shown in FIG. 2. This is referred to as a self-erecting structure of the separation module (10). The property of self-erection can be further enhanced if two segments (40) are connected to each other at the edge (i.e. in the area in which a segment (40) adjoins an adjacent segment (40)) at least at certain points. Then the segments (40) move up (or down when folded) with each other as it were, when the two corners of the folded separation module (10) that are furthest from each other are moved towards each other.

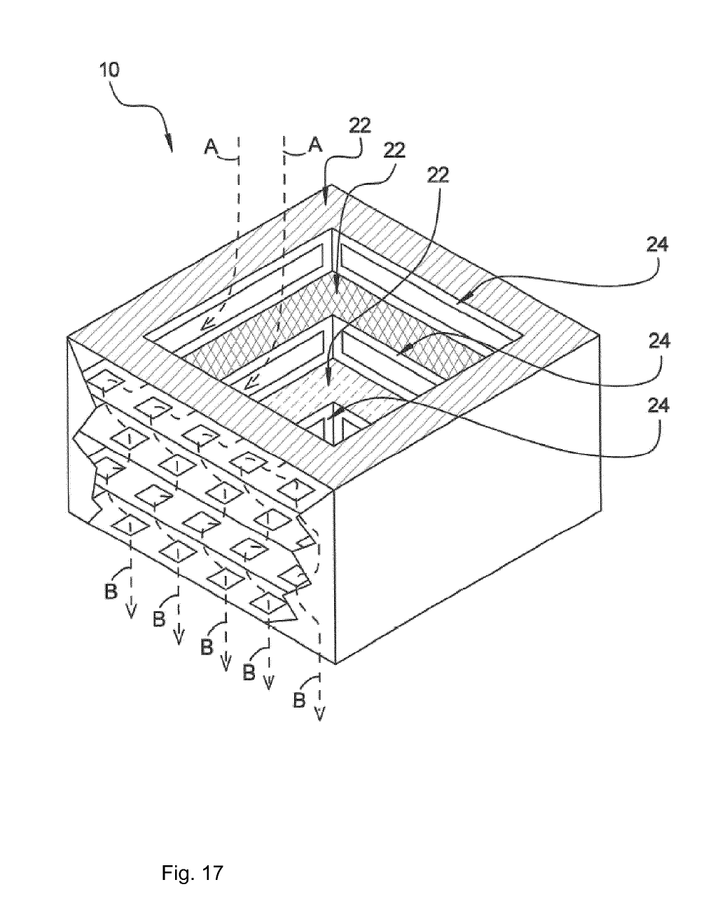

FIG. 14 shows a separation module (10) similar to FIG. 1, wherein horizontal faces (22) and vertical faces (24) have openings for the raw gas stream (A) to enter the interior of the separation module (10). The openings are shown as elongated (rectangular), continuous openings. In place of these continuous openings—and this also applies to the following representations—a plurality of individual openings may also be provided, in particular with the number of openings decreasing or increasing from level to level.

FIG. 15 shows a separation module (10) similar to that shown in FIG. 2, wherein horizontal faces (22) and vertical faces (24) have openings for the raw gas stream (A) to enter the interior of the separation module (10).

FIG. 16 shows a separation module (10) similar to that shown in FIG. 2, wherein only the horizontal faces (22) have openings for the raw gas stream (A) to enter the interior of the separation module (10).

The representation in FIG. 17 shows a separation module (10) similar to that shown in FIG. 2, with openings (32) that are vertically offset from one another in the separating faces (30) and the resulting multiple diversion of the raw gas stream (A) in the interior of the separation module (10). In contrast to this, FIG. 2 shows a design wherein the openings (32) in the separating faces (30) become smaller from level to level. Both represent a progressive structure of separating surfaces (30). The two variants can be combined with each other. All these variants of the progressive structure of course also apply to the design of the separation module (10) such as that shown in FIG. 1.

A few aspects of the description submitted here, which are in the foreground, can therefore be briefly summarized as follows: A separation module (10) with a stepped surface structure, wherein each step in the stepped surface structure has a horizontal face (22), and wherein at least one vertical face (24) adjoins each of the horizontal faces (22), wherein a vertical face (24) located between two horizontal faces (22) has at least one opening for the entry into the interior of the separation module (10) of a raw gas stream (A) containing overspray, wherein following a vertical face (24) provided with at least one opening, the interior of the separation module (10) contains a plurality of vertical channels (26) under some horizontal faces (22), and wherein at least some channels (26) comprise a plurality of chambers separated by separating faces (30) with a progressive structure, as well as the use of a separation module (10) of this type, for example in a device for separating ‘overspray’.

### REFERENCE SIGN LIST

10 Separation module
22 Horizontal face
24 Vertical face
26 Channel
28 Vertical boundary face
30 Separating face
32 Opening (in the separating face)
40 Segment (of the separation module)

1. A separation module (10) with a stepped surface structure,
wherein each step in the stepped surface structure has a horizontal face (22), and wherein at least one vertical face (24) adjoins each of the horizontal faces (22),
wherein a vertical face (24) located between two horizontal faces (22) has at least one opening for the entry of a raw gas stream (A) containing overspray into the interior of the separation module (10),
wherein following a vertical face (24) provided with at least one opening, the interior of the separation module (10) comprises a plurality of vertical channels (26) under some horizontal faces (22),
wherein at least some channels (26) comprise a plurality of chambers separated by separating faces (30) with a progressive structure.

2. A separation module (10) according to claim 1, featuring a vertical face (24) provided with at least one opening on each level of a plurality of levels, wherein each level is part of one step.

3. A separation module (10) according to claim 1, featuring a plurality of steps with vertical faces (24), each of which are circumferential and each of which is provided with at least one opening.

4. A separation module (10) according to claim 1, featuring at least a first and a second ring-shaped channel (26) in its base,
wherein the first and the second channel (26) share a center point,
wherein the first and the second channel (26) each have a horizontal face (22) delimiting the channel (26) in the inflow direction, and
wherein the horizontal face (22) of the first channel (26) and the horizontal face of the second channel (26) belong to different steps of the stepped surface structure.

5. A separation module (10) according to claim 1, wherein at least some channels (26) in the interior of the separation module (10) are delimited from adjacent channels (26) by means of closed vertical boundary faces (28).

6. A separation module (10) according to claim 1, featuring an inner part forming the stepped surface structure and an outer part framing the inner part.

7. A separation module (10) according to claim 6, wherein the inner part comprises the horizontal faces (22), vertical faces (24) and separating faces (30).

8. A separation module (10) according to claim 7, wherein the inner part is made of cardboard, in particular corrugated cardboard.

9. A separation module (10) according to claim 6, with a foldable, self-erecting inner part.

10. A separation module (10) according to claim 6, wherein the stepped surface structure results from the inner part being in the shape of a stepped pyramid.

11. A separation module (10) according to claim 6, wherein the stepped surface structure results in the shape of an inverse stepped pyramid due to an inner part.

12. A device for separating overspray with at least one separation module (10) according to claim 1.

13. A device according to claim 12 featuring a plurality of separation modules (10) which are placed next to and on top of one another, with each stepped surface structure being exposed to an incoming raw gas stream.

14. A separation module (10) according to claim 2, featuring a plurality of steps with vertical faces (24), each of which are circumferential and each of which is provided with at least one opening.

15. A separation module (10) according to claim 14, featuring at least a first and a second ring-shaped channel (26) in its base,
wherein the first and the second channel (26) share a center point,
wherein the first and the second channel (26) each have a horizontal face (22) delimiting the channel (26) in the inflow direction, and
wherein the horizontal face (22) of the first channel (26) and the horizontal face of the second channel (26) belong to different steps of the stepped surface structure.

16. A separation module (10) according to claim 15, wherein at least some channels (26) in the interior of the separation module (10) are delimited from adjacent channels (26) by means of closed vertical boundary faces (28).

17. A separation module (10) according to claim 16, featuring an inner part forming the stepped surface structure and an outer part framing the inner part, wherein the inner part comprises the horizontal faces (22), vertical faces (24) and separating faces (30).

18. A separation module (10) according to claim 17, wherein the inner part is made of cardboard, in particular corrugated cardboard, with a foldable, self-erecting inner part.

19. A separation module (10) according to claim 18, wherein the stepped surface structure results from the inner part being in the shape of a stepped pyramid, wherein the stepped surface structure results in the shape of an inverse stepped pyramid due to an inner part.

20. A device for separating overspray with a plurality of separation modules (10) each according to claim 19, which are placed next to and on top of one another, with each stepped surface structure being exposed to an incoming raw gas stream.
